(19) United States
(12) Patent Application Publication
(10) Pub. No.: US 2025/0293463 A1
(43) Pub. Date: Sep. 18, 2025

(54) CONNECTOR

(71) Applicant: SUMITOMO WIRING SYSTEMS, LTD., Mie (JP)

(72) Inventors: Yuki HIROSE, Mie (JP); Takanobu YAMAGAMI, Mie (JP)

(21) Appl. No.: 19/072,526

(22) Filed: Mar. 6, 2025

(30) Foreign Application Priority Data
Mar. 14, 2024 (JP) 2024-040003

(51) Int. Cl. H01R 13/631

(52) U.S. Cl. CPC H01R 13/631

(57) ABSTRACT

A connector includes a terminal and a housing for holding the terminal. The terminal includes a female terminal portion extending along a first axis and a wire connecting portion extending along a second axis intersecting the first axis. The female terminal portion includes a groove-like connecting portion to be connected to the wire connecting portion and a tubular portion extending in a forward direction from an end part of the connecting portion, the forward direction being one direction along the first axis. The connecting portion is open in a rearward direction opposite to the forward direction. The housing includes a housing body having a terminal accommodating portion for accommodating the terminal and a cover member to be attached to the housing body. The cover member includes a projection to be inserted inside the connecting portion and formed to be engageable with the connecting portion along the second axis.

### CROSS-REFERENCE TO RELATED APPLICATIONS

This application is based on and claims priority from Japanese Patent Application No. 2024-040003, filed on Mar. 14, 2024, with the Japan Patent Office, the disclosure of which is incorporated herein in its entirety by reference.

### TECHNICAL FIELD

The present disclosure relates to a connector.

### BACKGROUND

Conventionally, a connector used to control an airbag inflator or the like, i.e. a so-called squib connector, is installed in a vehicle (see, for example, Japanese Patent Laid-open Publication No. 2016-021397). The connector of this type is provided with a terminal, a housing for holding the terminal, a slider accommodated inside the housing and a spring for biasing the slider. In this connector, the connection of the connector and a mating connector is guaranteed by sliding the slider by a biasing force of the spring.

### SUMMARY

In the above connector, it is desired to suppress a positional deviation of the terminal inside the housing.

The present disclosure aims to provide a connector capable of suppressing a positional deviation of a terminal inside a housing.

The present disclosure is directed to a connector with a terminal, a housing for holding the terminal, a slider to be accommodated inside the housing, the slider being movable to a first position and a second position along a first axis, and a spring for biasing the slider, the terminal including a female terminal portion extending along the first axis and a wire connecting portion extending along a second axis intersecting the first axis, the female terminal portion including a groove-like connecting portion to be connected to the wire connecting portion and a tubular portion extending in a first direction from an end part of the connecting portion, the first direction being one direction along the first axis, the connecting portion being open in a first opposite direction opposite to the first direction, the housing including a housing body having a terminal accommodating portion for accommodating the terminal and a cover member to be attached to the housing body, and the cover member including a projection to be inserted inside the connecting portion, the projection being formed to be engageable with the connecting portion along the second axis.

According to the connector of the present disclosure, an effect of being able to suppress a positional deviation of the terminal is achieved.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view showing a connector according to one embodiment and a mating connector.

FIG. 2 is an exploded perspective view showing the connector of the embodiment.

FIG. 3 is a perspective view in section showing a part of the connector of the embodiment.

FIG. 4 is a plan view showing a part of the connector of the embodiment.

FIG. 5 is a section (along 5-5 in FIG. 4) showing the connector of the embodiment.

FIG. 6 is a perspective view showing a cover member of the embodiment.

FIG. 7 is a section (along 7-7 in FIG. 4) showing the connector of the embodiment.

FIG. 8 is a section (along 8-8 in FIG. 5) showing the connector of the embodiment.

FIG. 9 is a section (along 9-9 in FIG. 4) showing the connector of the embodiment.

FIG. 10 is a section showing the connector of the embodiment.

FIG. 11 is a section (along 11-11 in FIG. 4) showing the connector of the embodiment and the mating connector.

FIG. 12 is a section showing the connector of the embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

First, embodiments of the present disclosure are listed and described.

[1] The connector of the present disclosure is provided with a terminal, a housing for holding the terminal, a slider to be accommodated inside the housing, the slider being movable to a first position and a second position along a first axis, and a spring for biasing the slider, the terminal including a female terminal portion extending along the first axis and a wire connecting portion extending along a second axis intersecting the first axis, the female terminal portion including a groove-like connecting portion to be connected to the wire connecting portion and a tubular portion extending in a first direction from an end part of the connecting portion, the first direction being one direction along the first axis, the connecting portion being open in a first opposite direction opposite to the first direction, the housing including a housing body having a terminal accommodating portion for accommodating the terminal and a cover member to be attached to the housing body, and the cover member including a projection to be inserted inside the connecting portion, the projection being formed to be engageable with the connecting portion along the second axis.

According to this configuration, if the cover member is attached to the housing body accommodating the terminal in the terminal accommodating portion, the projection of the cover member is inserted into the groove-like connecting portion. At this time, the projection is provided to be engageable with the connecting portion along the second axis. By the engagement of these connecting portion and projection, the terminal can be suitably suppressed from moving along the second axis inside the housing. As a result, a positional deviation of the terminal inside the housing can be suitably suppressed.

[2] In [1] described above, the housing body may be formed into a box open in the first opposite direction, and the cover member may include a body portion for closing an opening in the first opposite direction of the housing body and the projection projecting in the first direction from the body portion.

According to this configuration, the housing is formed into a tube surrounding the outer periphery of the terminal by attaching the cover member to the housing body. Further, by attaching the cover member to the housing body, the projection of the cover member can be suitably inserted along the first direction into the connecting portion open in the first opposite direction. In this way, the connecting portion and the projection can be engaged with each other along the second axis, wherefore a movement of the terminal inside the housing can be suitably suppressed.

[3] In [2] described above, the connecting portion may include a base portion, a first wall portion provided in an end part in a second direction of the base portion, the second direction being one direction along the second axis, and a second wall portion provided in an end part in a second opposite direction of the base portion, the second opposite direction being opposite to the second direction, each of the first wall portion and the second wall portion may project in a third direction intersecting both the first direction and the second direction, and the projection may be formed to be engageable with the first wall portion in the second direction and formed to be engageable with the second wall portion in the second opposite direction.

According to this configuration, the projection is provided to be engageable with the first wall portion of the connecting portion in the second direction. By the engagement of these projection and first wall portion, the terminal can be suitably suppressed from moving in the second opposite direction inside the housing. Further, the projection is provided to be engageable with the second wall portion of the connecting portion in the second opposite direction. By the engagement of these projection and second wall portion, the terminal can be suitably suppressed from moving in the second direction inside the housing. As just described, by the engagement of the projection and the first and second wall portions, the terminal can be suitably suppressed from moving in the second direction and the second opposite direction inside the housing. As a result, a positional deviation of the terminal inside the housing can be suitably suppressed.

[4] In [3] described above, the cover member may include a rotation restricting portion extending in the second opposite direction from the projection, and the rotation restricting portion may be formed to be engageable with the second wall portion in a rotation direction of the terminal around the first axis.

According to this configuration, the rotation restricting portion of the cover member is formed to be engageable with the second wall portion in the rotation direction around the first axis. By the engagement of the second wall portion with this rotation restricting portion, the rotation of the terminal around the first axis can be restricted. In this way, a positional deviation of the terminal associated with the rotation of the terminal can be suitably suppressed.

[5] In [4] described above, the connecting portion may include a cut portion provided in an end part in the first opposite direction of the first wall portion, the projection may include a cylindrical base end part connected to the body portion and a cylindrical tip part projecting in the first direction from the base end part, an outer diameter of the tip part may be smaller than an outer diameter of the base end part, and an end surface in the first direction of the base end part may be formed to be engageable with an end surface in the first opposite direction of the first wall portion exposed by the cut portion along the first axis.

According to this configuration, the base end part of the projection is provided to be engageable with the first wall portion of the connecting portion along the first axis. By the engagement of these base end part and first wall portion, the terminal can be suitably suppressed from moving in the first opposite direction inside the housing. As a result, a positional deviation of the terminal inside the housing can be suitably suppressed.

[6] In [5] described above, the second wall portion may be facing the rotation restricting portion in the third direction, the projection may have an engaging surface extending in the third direction from the tip part, the first wall portion may be formed into a curved shape along an outer peripheral surface of the tip part, and the engaging surface may be formed to be engageable with an end surface in a circumferential direction of the first wall portion in the rotation direction.

According to this configuration, the engaging surface of the cover member is formed to be engageable with the end surface in the circumferential direction of the first wall portion in the rotation direction around the first axis. By the engagement of the first wall portion with this engaging surface, the rotation of the terminal around the first axis can be restricted. In this way, a positional deviation of the terminal associated with the rotation of the terminal can be suitably suppressed.

[7] In any one of [2] to [6] described above, the cover member may include a position restricting portion projecting in the first direction from the body portion, and the position restricting portion may be formed to be engageable with the wire connecting portion along the first axis.

According to this configuration, the position restricting portion is provided to be engageable with the wire connecting portion along the first axis. By the engagement of these position restricting portion and wire connecting portion, the terminal can be suitably suppressed from moving in the first opposite direction inside the housing. As a result, a positional deviation of the terminal inside the housing can be suitably suppressed.

### Details of Embodiment of Present Disclosure

A specific example of a connector of the present disclosure is described below

with reference to the drawings. For the convenience of description, some components may be shown in an exaggerated or simplified manner in each drawing. Further, a dimension ratio of each part may be different in each figure. Further, “orthogonal” and “parallel” in this specification mean not only strictly orthogonal and parallel, but also substantially orthogonal and parallel within a range in which functions and effects in this embodiment are achieved. Note that a term “tubular” used in the description of this specification indicates not only a shape formed by a peripheral wall continuous over an entire periphery in a circumferential direction, but also a shape formed by combining a plurality of components and a shape having a cut or the like in a circumferential part such as a C shape or a U shape. Note that “tubular” shapes include circular shapes, elliptical shapes and polygonal shapes with angular or round corners, but there is no limitation to these. “Facing each other” in this specification indicates that surfaces or members are at positions in front of each other, and means not only a case where the surfaces or members are at positions perfectly in front of each other, but also a case where the surfaces or members are partially in front of each other. “Facing each other” in this specification means not only a case where two members are separated from each other, but also a case where the two members are in contact with each other. Further, terms such as “first”, “second” and “third” in this specification are merely used to distinguish objects and do not rank the objects. Note that the present invention is not limited to these illustrations, but is represented by claims and intended to include all changes in the scope of claims and in the meaning and scope of equivalents.

### Overall Configuration of Connector 10

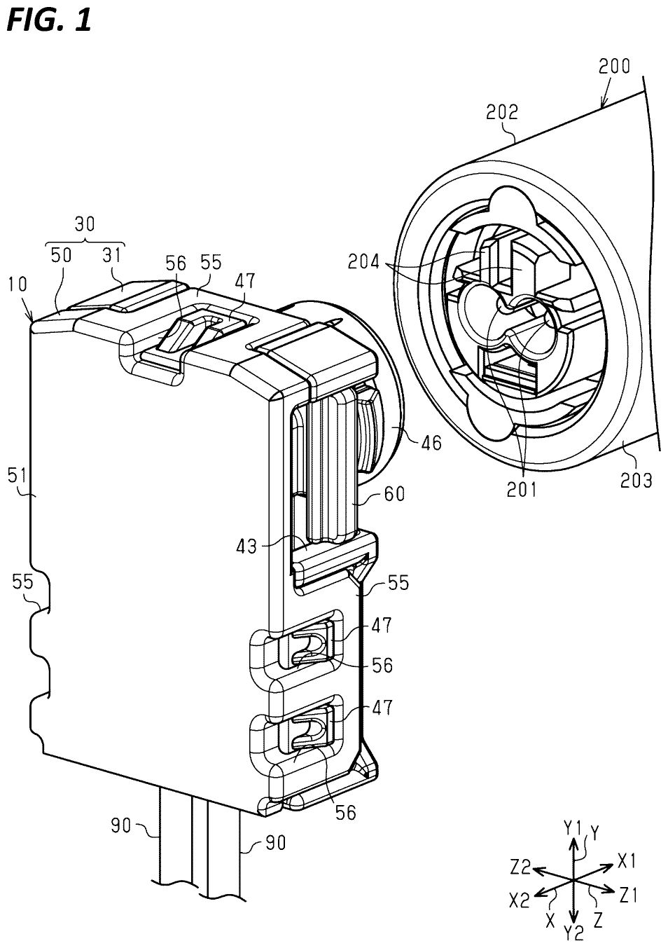

As shown in FIG. 1, a connector 10 is configured to be connectable to a mating connector 200. The connector 10 is, for example, provided in an unillustrated vehicle such as a hybrid vehicle or an electric vehicle. Further, the connector 10 is a connector used to control a seat belt pretensioner, an airbag inflator or the like of the vehicle, i.e. a so-called squib connector.

A first axis X, a second axis Y orthogonal to the first axis X and a third axis Z orthogonal to both the first and second axes X, Y are shown in each figure. Further, a forward direction X1, which is one direction along the first axis X, and a rearward direction X2, which is another direction along the first axis X and a direction opposite to the forward direction X1, are shown in each figure. Here, the forward direction X1 is a forward direction along a connection direction of the connector 10 to the mating connector 200. An upward direction Y1, which is one direction along the second axis Y, and a downward direction Y2, which is another direction along the second axis Y and a direction opposite to the upward direction Y1, are shown in each figure. A first width direction Z1, which is one direction along the third axis Z, and a second width direction Z2, which is another direction along the third axis Z and a direction opposite to the first width direction Z1, are shown in each figure. Note that each direction in each figure does not necessarily indicate postures of the connector 10 and the mating connector 200 during use. Further, the description of directions in the mating connector 200 is based on a state where the mating connector 200 is connected to the connector 10.

### Configuration of Mating Connector 200

The mating connector 200 includes mating terminals 201 and a mating housing 202 for holding the mating terminals 201. The mating housing 202 includes a mating-side fitting tube portion 203 to be fit to a housing 30 of the connector 10 and a mating-side connection guaranteeing portion 204 for guaranteeing the connection of the connector 10 and the mating connector 200. The mating-side connection guaranteeing portion 204 is provided inside the mating-side fitting tube portion 203. The mating terminals 201 are provided inside the mating-side fitting tube portion 203.

### Configuration of Connector 10

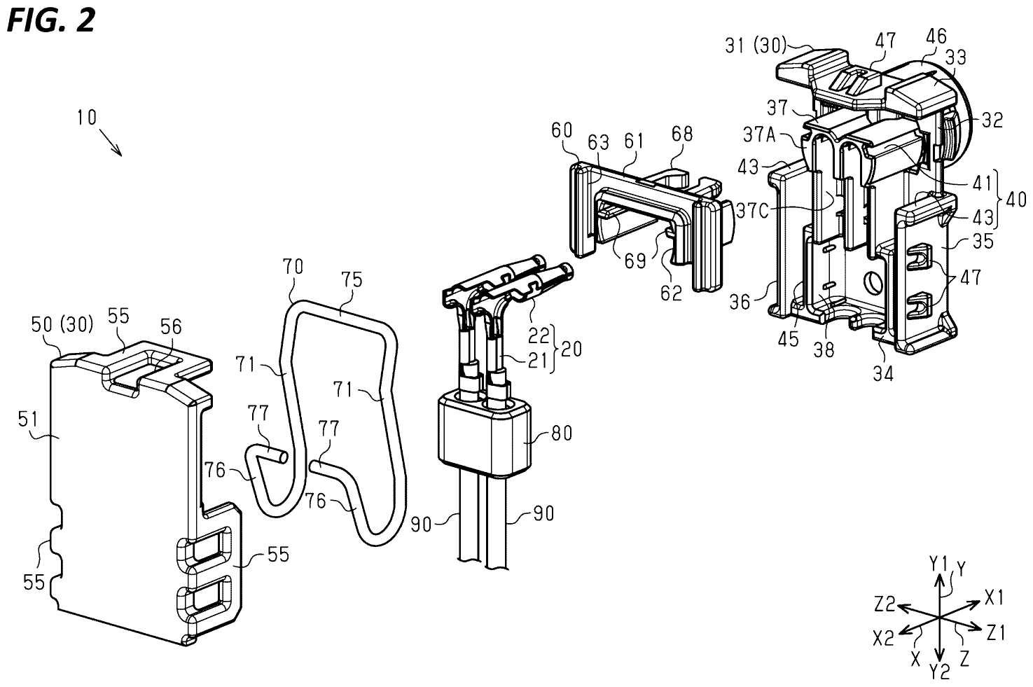

As shown in FIG. 2, the connector 10 is provided with terminals 20, the housing 30, a slider 60, a spring 70 and a ferrite core 80. The connector 10 of this embodiment is provided with two terminals 20.

### Configuration of Terminals 20

The two terminals 20 are provided side by side along the third axis Z. Each terminal 20 includes a wire connecting portion 21 and a female terminal portion 22. The wire connecting portion 21 extends along the second axis Y. The female terminal portion 22 extends along the first axis X. Each terminal 20 is L-shaped as a whole. Each terminal 20 is made of metal.

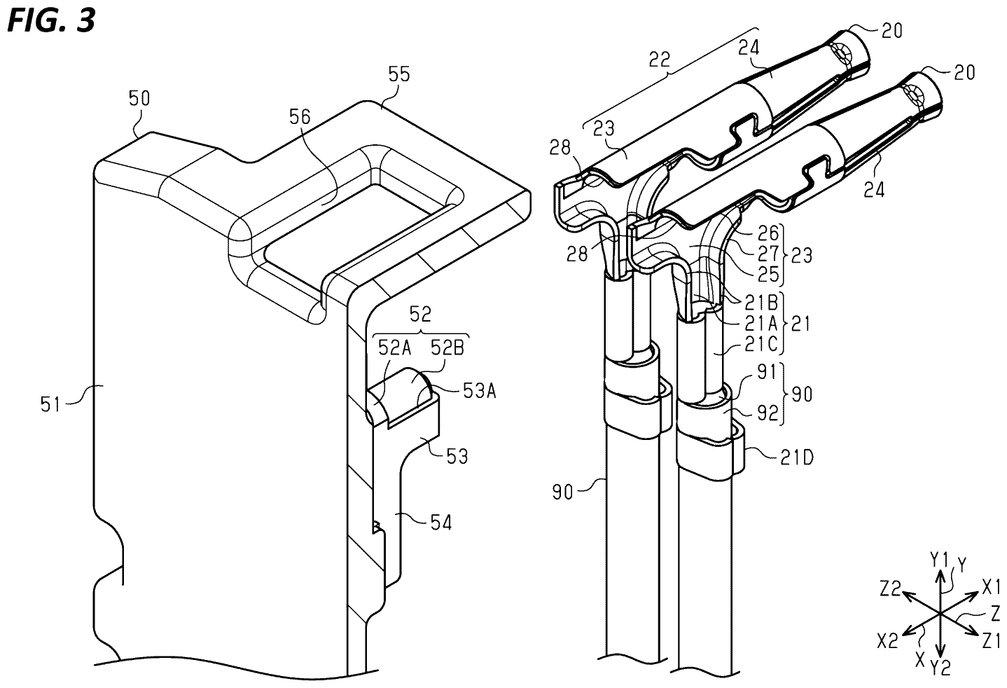

As shown in FIG. 3, the wire connecting portion 21 is connected to a wire 90. Here, the wire 90 is a coated wire including an electrically conductive core wire 91 and an insulation coating 92 covering the outer periphery of the core wire 91. An end part of the core wire 91 and an end part of the insulation coating 92 are exposed in an end part of the wire 90.

The wire connecting portion 21 is electrically connected to the end part of the core wire 91 exposed from the insulation coating 92. The wire connecting portion 21 includes a base portion 21A, a pair of side walls 21B projecting in the first width direction Z1 from the base portion 21A, a core wire connecting portion 21C and a coating connecting portion 21D.

The base portion 21A is in the form of a strip extending along the second axis Y. The pair of side walls 21B are provided to face each other along the first axis X.

The core wire connecting portion 21C is connected to the end part of the core wire 91 exposed from the insulation coating 92. The core wire connecting portion 21C and the core wire 91 can be joined, for example, by crimping, ultrasonic welding or the like. The core wire connecting portion 21C of this embodiment is joined to the core wire 91 by crimping. The coating connecting portion 21D is connected to the end part of the insulation coating 92. The coating connecting portion 21D of this embodiment is crimped to the end part of the insulation coating 92.

A part of the wire connecting portion 21 on a side further in the upward direction Y1 than the core wire connecting portion 21C is formed into a groove open in the first width direction Z1 by the base portion 21A and the pair of side walls 21B.

The female terminal portion 22 is connected to an end part in the upward direction Z1 of the wire connecting portion 21. The female terminal portion 22 extends in a direction orthogonal to a length direction of the wire connecting portion 21. The female terminal portion 22 includes a connecting portion 23 to be connected to the wire connecting portion 21 and a tubular portion 24.

The connecting portion 23 is formed into a groove open in the first width direction Z1. The connecting portion 23 is open in the forward direction X1 and the rearward direction X2. The connecting portion 23 extends in the forward direction X1 from the wire connecting portion 21 and extends in the rearward direction X2 from the wire connecting portion 21.

The connecting portion 23 includes a base portion 25 and a first wall portion 26 and a second wall portion 27 projecting in the first width direction Z1 from the base portion 25.

The base portion 25 is in the form of a strip extending along the first axis X. The base portion 25 is integrally formed to be continuous with the base portion 21A.

The first wall portion 26 is provided in an end part in the upward direction Y1 of the base portion 25. The first wall portion 26 is formed to be curved and project from the base portion 25. The first wall portion 26 extends along the first axis X. The first wall portion 26 is provided with a cut portion 28. The cut portion 28 is formed by cutting an end part in the rearward direction X2 of the first wall portion 26.

The second wall portion 27 is provided in an end part in the downward direction Y2 of the base portion 25. The second wall portion 27 is integrally formed to be continuous with each of the pair of side walls 21B. The second wall portion 27 projects straight along the third axis Z from the base portion 25. The second wall portion 27 extends along the first axis X. The second wall portion 27 is partially cut to allow mutual communication between an internal space of the connecting portion 23 and that of the wire connecting portion 21.

The tubular portion 24 is in the form of a tube extending in the forward direction X1 from an end part in the forward direction X1 of the connecting portion 23. The mating terminal 201 shown in FIG. 1 is inserted into the tubular portion 24. An internal space of the tubular portion 24 communicates with that of the connecting portion 23.

### Configuration of Housing 30

As shown in FIG. 2, the housing 30 includes a housing body 31 and a cover member 50 formed to be attachable to the housing body 31. The housing body 31 is in the form of a box open in the rearward direction X2. The cover member 50 is attached to the housing body 31 to close an opening of the housing body 31. The housing body 31 and the cover member 50 are separate members. Each of the housing body 31 and the cover member 50 is made of resin.

The housing 30 is formed into a tube surrounding the terminals 20, the slider 60 and the spring 70 by uniting the housing body 31 and the cover member 50. In other words, the terminals 20, the slider 60 and the spring 70 are accommodated in an internal space of the housing 30 formed by the housing body 31 and the cover member 50.

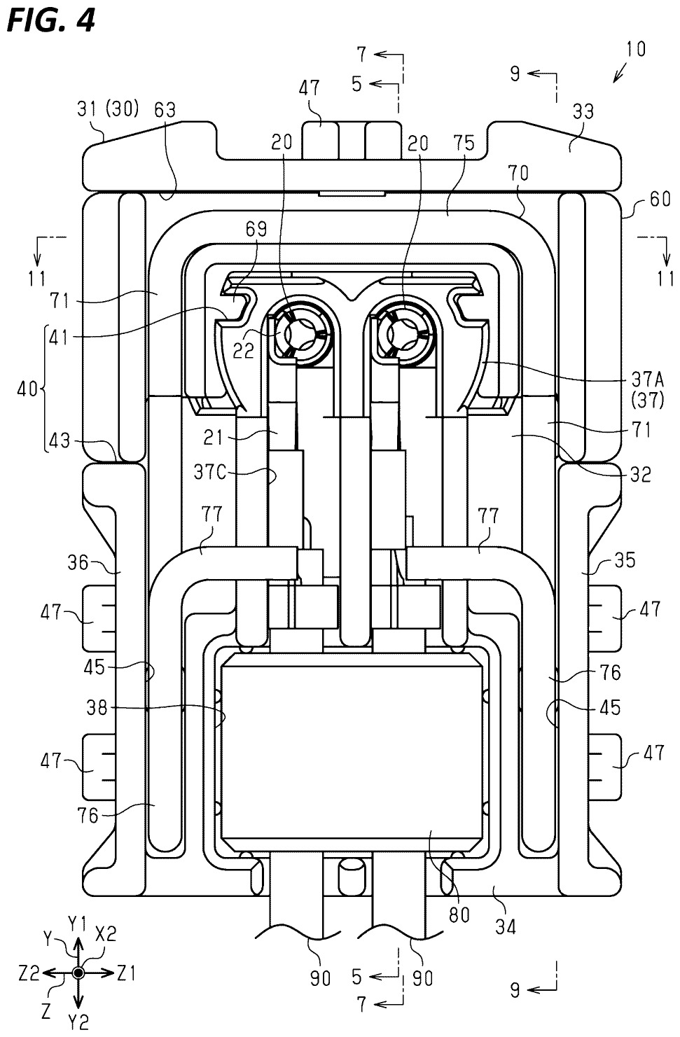

As shown in FIGS. 2 and 4, the housing body 31 includes a base portion 32 and peripheral walls 33, 34, 35 and 36 projecting in the rearward direction X2 from the base portion 32. The housing body 31 includes a terminal accommodating portion 37 for accommodating the terminals 20 and a ferrite accommodating portion 38 for accommodating the ferrite core 80. The housing body 31 includes a mounting portion 40, into which the slider 60 is mounted, and spring accommodating portions 45 for accommodating the spring 70. As shown in FIG. 4, the housing body 31 of this embodiment includes two spring accommodating portions 45. Note that the cover member 50 is not shown in FIG. 4 to simplify FIG. 4.

As shown in FIG. 2, the base portion 32 is in the form of a flat plate. The peripheral wall 33 is provided in an end part in the upward direction Y1 of the base portion 32. The peripheral wall 34 is provided in an end part in the downward direction Y2 of the base portion 32. The peripheral walls 33, 34 extend along the third axis Z. The peripheral wall 35 is provided in an end part in the first width direction Z1 of the base portion 32. The peripheral wall 36 is provided in an end part in the second width direction Z2 of the base portion 32. The peripheral walls 35, 36 extend along the second axis Y.

The terminal 20 is inserted along the forward direction X1 into the terminal accommodating portion 37. The terminal accommodating portion 37 is so formed that the two terminals 20 arranged along the third axis Z can be held.

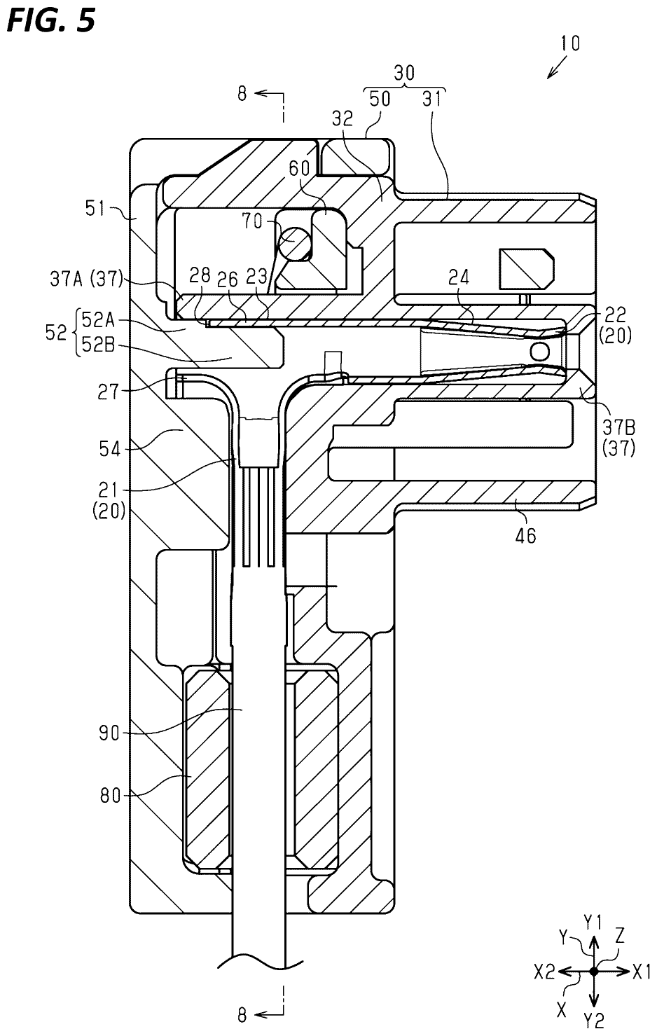

As shown in FIG. 5, the terminal accommodating portion 37 includes a tubular portion 37A projecting in the rearward direction X2 from the base portion 32 and a tubular portion 37B projecting in the forward direction X1 from the base portion 32. An internal space of the tubular portion 37A and that of the tubular portion 37B communicate with each other. The female terminal portions 22 of the terminals 20 are accommodated into the tubular portions 37A, 37B.

As shown in FIG. 2, the terminal accommodating portion 37 includes accommodation grooves 37C for accommodating the wire connecting portions 21 of the terminals 20. The accommodation groove 37C extends along the downward direction Y2 from the tubular portion 37A. An internal space of the accommodation groove 37C communicates with that of the tubular portion 37A.

The ferrite core 80 mounted on the outer peripheries of the wires 90 is inserted along the forward direction X1 into the ferrite accommodating portion 38. The ferrite accommodating portion 38 extends along the downward direction Y2 from the accommodation grooves 37C of the terminal accommodating portion 37. An internal space of the ferrite accommodating portion 38 communicates with those of the accommodation grooves 37C.

The slider 60 is mounted along the forward direction X1 into the mounting portion 40. The mounting portion 40 holds the slider 60 movably along the first axis X in an internal space of the housing 30. The mounting portion 40 includes guide grooves 41 provided in the outer peripheral surfaces of the tubular portions 37A and cut portions 43 provided in the peripheral walls 35, 36.

Guide protrusions 69 of the slider 60 are inserted along the forward direction X1 into the guide grooves 41. The guide groove 41 extends along the first axis X. The guide groove 41 extends over the entire length in an axial direction of the tubular portion 37A.

The cut portion 43 is provided in each of the peripheral walls 35, 36. The cut portions 43 are formed by cutting end parts in the upward direction Y1 of the peripheral walls 35, 36.

The two spring accommodating portions 45 are respectively provided in both end parts along the third axis Z. An arm 71 of the spring 70 is inserted along the forward direction X1 into each spring accommodating portion 45. As shown in FIG. 4, the spring accommodating portion 45 is in the form of a groove extending along the second axis Y. The spring accommodating portion 45 provided in an end part in the first width direction Z1 is formed by being surrounded by the outer peripheral surface of the ferrite accommodating portion 38 and the peripheral walls 34, 35. The spring accommodating portion 47 provided in an end part in the second width direction Z1 is formed by being surrounded by the outer peripheral surface of the ferrite accommodating portion 38 and the peripheral walls 34, 36.

As shown in FIG. 1, the housing body 31 includes a fitting tube portion 46 to be fit into the mating-side fitting tube portion 203 of the mating housing 202. The fitting tube portion 46 is fit into the mating-side fitting tube portion 203. As shown in FIG. 2, the fitting tube portion 46 projects in the forward direction X1 from the base portion 32.

As shown in FIG. 4, the housing body 31 includes engaging portions 47 provided on the peripheral walls 33, 35 and 36. The engaging portion 47 is an engaging projection projecting outward from the outer surface of the peripheral wall 33, 35, 36. The peripheral wall 33 is provided with one engaging portion 47. Each of the peripheral walls 35, 36 is provided with two engaging portions 47.

### Configuration of Cover Member 50

As shown in FIG. 1, the cover member 50 is attached to the housing body 31. The cover member 50 is formed to be detachably attachable to the housing body 31.

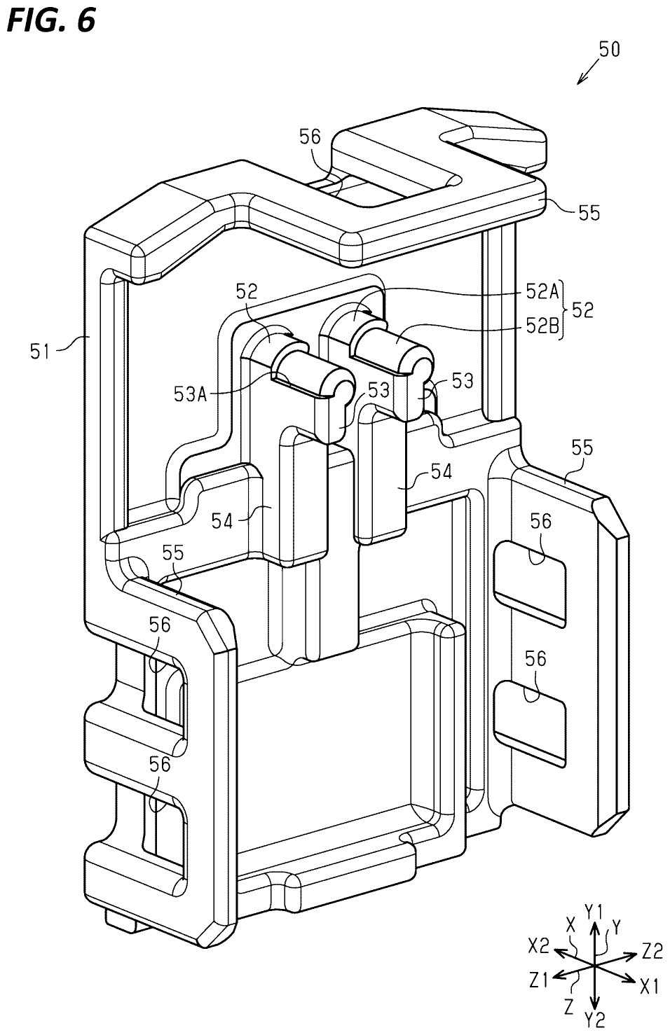

As shown in FIG. 6, the cover member 50 includes a body portion 51, projections 52 projecting in the forward direction X1 from the body portion 51 and rotation restricting portions 53 projecting in the downward direction Y2 from the projections 52. The cover member 50 includes position restricting portions 54 projecting in the forward direction X1 from the body portion 51 and engaging portions 55 projecting in the forward direction X1 from the body portion 51. The cover member 50 of this embodiment includes two projections 52, two rotation restricting portions 53 and two position restricting portions 54 respectively corresponding to the two terminals 20 (see FIG. 2).

As shown in FIG. 2, the body portion 51 is in the form of a flat plate. The body portion 51 is formed to close an opening in the rearward direction X2 of the housing body 31.

As shown in FIG. 5, each projection 52 projects toward the terminal 20 from the inner surface of the cover member 50, i.e. from an end surface in the forward direction X1 of the body portion 51. Each projection 52 is inserted into an internal space of the connecting portion 23 of the terminal 20. Each projection 52 is formed to be engageable with the connecting portion 23 along the second axis Y. Each projection 52 has a function of restricting a movement of the terminal 20 in the upward direction Y1 and a movement of the terminal 20 in the downward direction Y2 by being inserted into the internal space of the connecting portion 23.

As shown in FIG. 6, each projection 52 includes a base end part 52A connected to the body portion 51 and a tip part 52B projecting in the forward direction X1 from the base end part 52A. The base end part 52A is formed into a cylindrical shape as a whole. The tip part 52B is formed into a cylindrical shape as a whole. An outer diameter of the base end part 52A is larger than that of the tip part 52B. Thus, a step is formed in a boundary part between the base end part 52A and the tip part 52B.

As shown in FIG. 5, a part of the base end part 52A is inserted into the internal space of the connecting portion 23. An end surface in the forward direction X1 of the base end part 52A is facing an end surface in the rearward direction X2 of the first wall portion 26 of the connecting portion 23. Specifically, the end surface in the forward direction X1 of the base end part 52A is formed to be engageable with the end surface in the rearward direction X2 of the first wall portion 26 exposed by the cut portion 28 along the first axis X. The base end part 52A is formed to be engageable with the second wall portion 27 in the downward direction Y2.

The tip part 52B is entirely inserted into the internal space of the connecting portion 23. The tip part 52B is formed to be engageable with the first wall portion 26 in the upward direction Y1. The tip part 52B is formed to be engageable with the second wall portion 27 in the downward direction Y2. In this way, the tip part 52B is formed to be engageable with the connecting portion 23 in both directions along the second axis Y, i.e. in the upward direction Y1 and the downward direction Y2. Note that, as shown in FIG. 3, the first wall portion 26 is formed into a curved shape curved along the outer peripheral surface of the cylindrical tip part 52B.

Each rotation restricting portion 53 projects in the downward direction Y2 from the tip part 52B of each projection 52. Each rotation restricting portion 53 is formed to project further in the first width direction Z1 than the tip part 52B. In this way, a boundary part between the rotation restricting portion 53 and the tip part 52B is formed with a step and an engaging surface 53A facing in the upward direction Y1. The engaging surface 53A extends in the first width direction Z1 from the tip part 52B and extends along the first axis X.

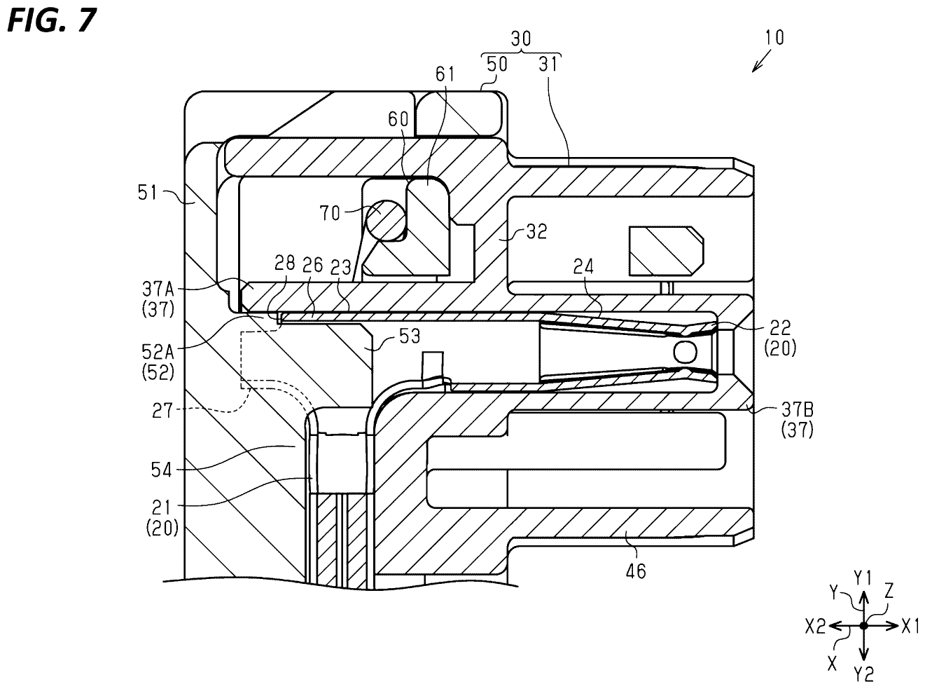

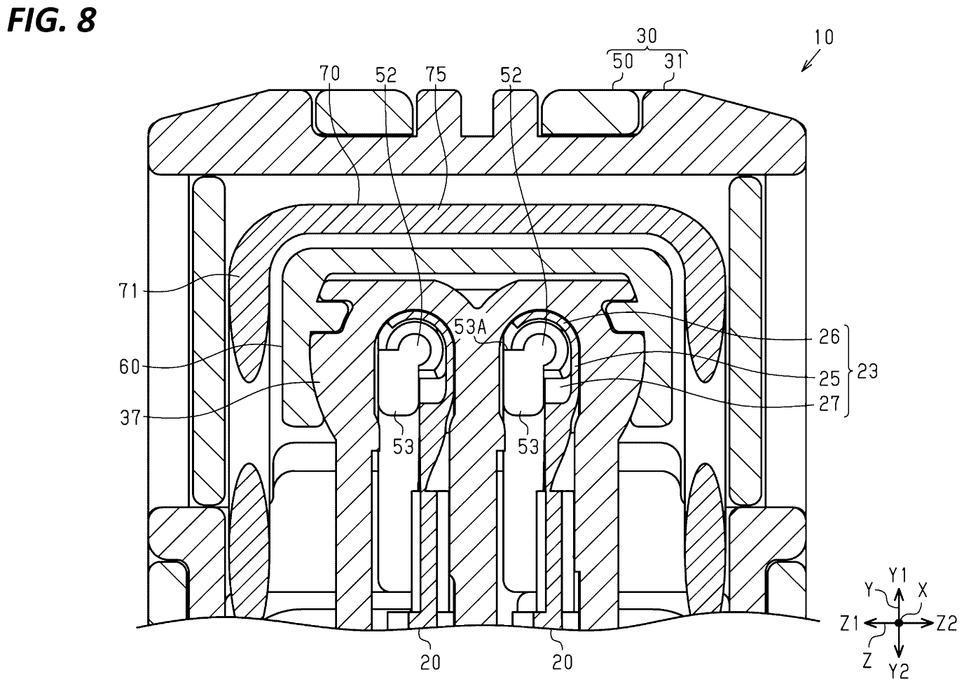

As shown in FIGS. 7 and 8, each rotation restricting portion 53 is provided to face the second wall portion 27 along the third axis Z. As shown in FIG. 8, each rotation restricting portion 53 is formed to be engageable with the second wall portion 27 in a rotation direction of the terminal 20 around the first axis X. Each rotation restricting portion 53 has a function of restricting the rotation of the terminal 20 in one rotation direction around the first axis X, here in a clockwise direction. The engaging surface 53A is formed to be engageable with an end surface in a circumferential direction of the first wall portion 26 in the rotation direction of the terminal 20 around the first axis X. The engaging surface 53A has a function of restricting the rotation of the terminal 20 in one rotation direction around the first axis X, here in a counterclockwise direction. Note that the rotation of the terminal 20 in the counterclockwise direction is restricted also by a wall portion constituting the terminal accommodating portion 37 with the terminal 20 accommodated in the terminal accommodating portion 37 of the housing body 31.

As shown in FIG. 5, each position restricting portion 54 is provided to face the wire connecting portion 21 of each terminal 20 along the first axis X. Each position restricting portion 54 is formed to be engageable with each wire connecting portion 21 along the first axis X. Each position restricting portion 54 is provided to be able to come into surface contact with each wire connecting portion 21. Each position restricting portion 54 is formed to be able to press each wire connecting portion 21 in the forward direction X1. Each position restricting portion 54 has a function of restricting a movement of the terminal 20 in the rearward direction X2. Each position restricting portion 54 extends along the second axis Y. As shown in FIG. 6, each position restricting portion 54 is integrally formed to be continuous with the rotation restricting portion 53.

As shown in FIG. 1, the cover member 50 of this embodiment includes three engaging portions 55 corresponding to the engaging portions 47 of the housing body 31. Each engaging portion 55 projects toward the housing body 31 from the body portion 51. Each engaging portion 55 is a resilient piece formed to be resiliently deformable. Each engaging portion 55 is formed into a frame body. Each engaging portion 55 includes an engaging hole 56 engageable with the engaging portion 47. The engaging portion 47 and the engaging hole 56 are engaged with each other by snap fitting, utilizing the resilient deformation of the engaging portion 55. A united state of the housing body 31 and the cover member 50 is maintained by the engagement of the engaging portions 47 and the engaging holes 56.

### Configuration of Slider 60

As shown in FIG. 2, the slider 60 includes a body portion 61, a spring accommodating portion 63, a connection guaranteeing portion 68 and the guide protrusions 69. The slider 60 is a single component integrally formed with the body portion 61, the spring accommodating portion 63, the connection guaranteeing portion 68 and the guide protrusions 69. The slider 60 is made of resin.

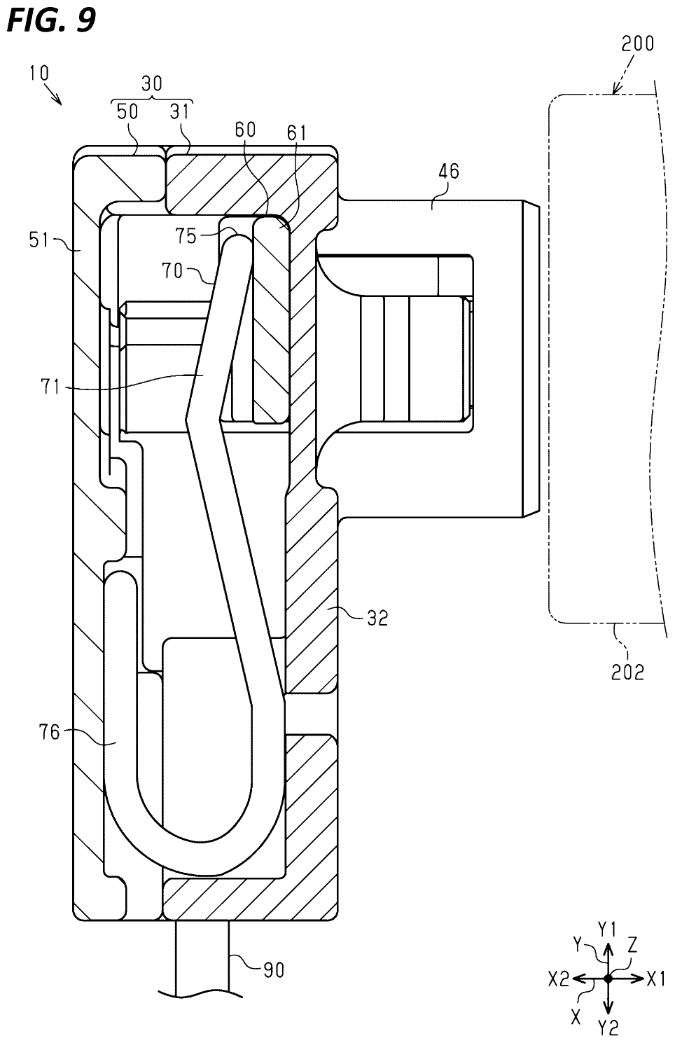

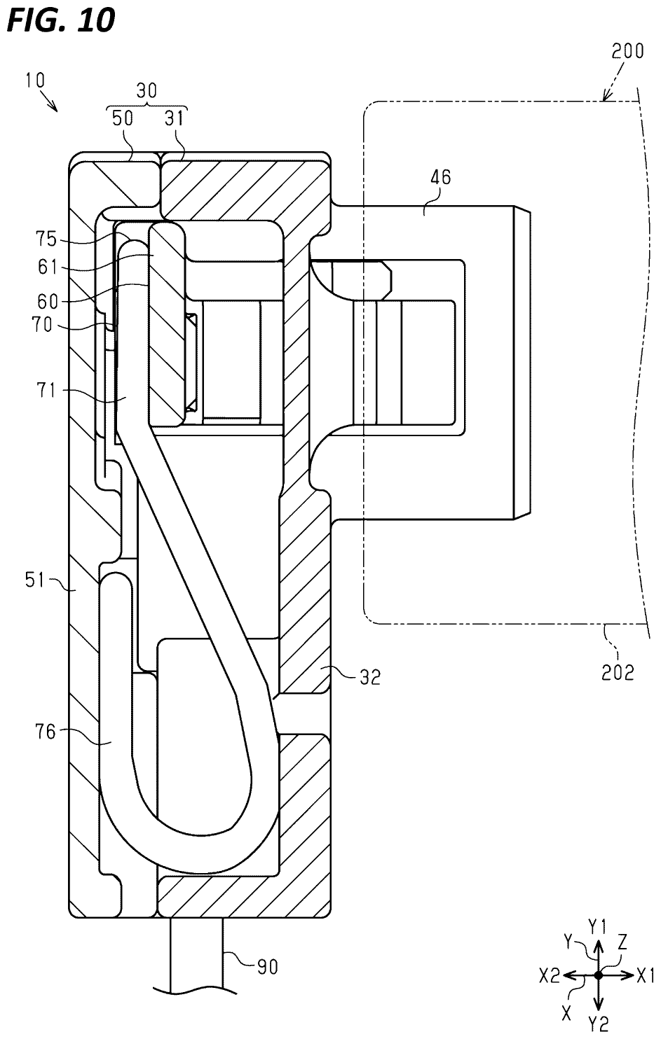

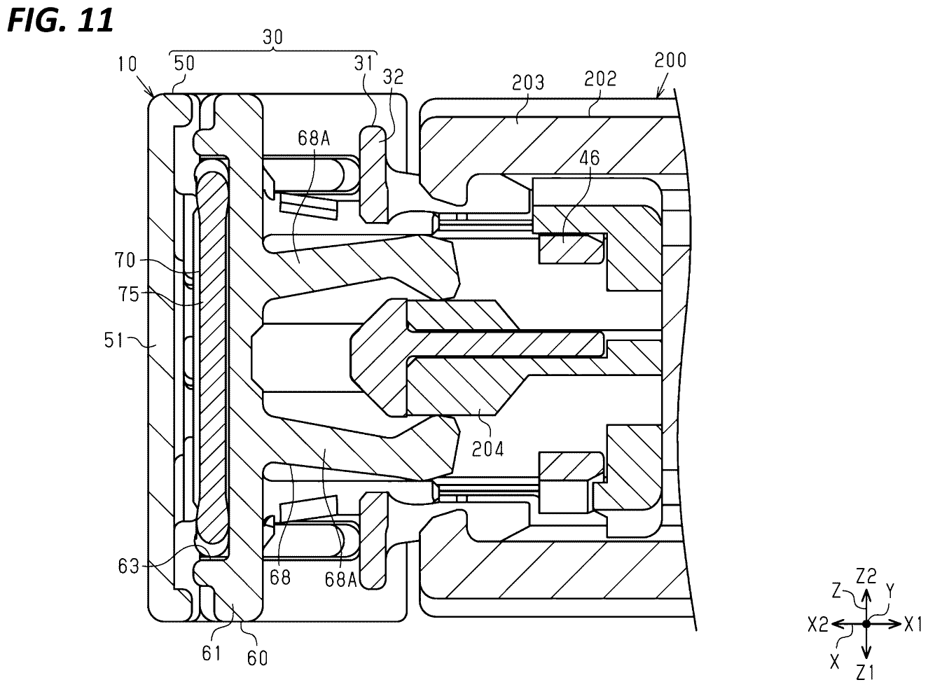

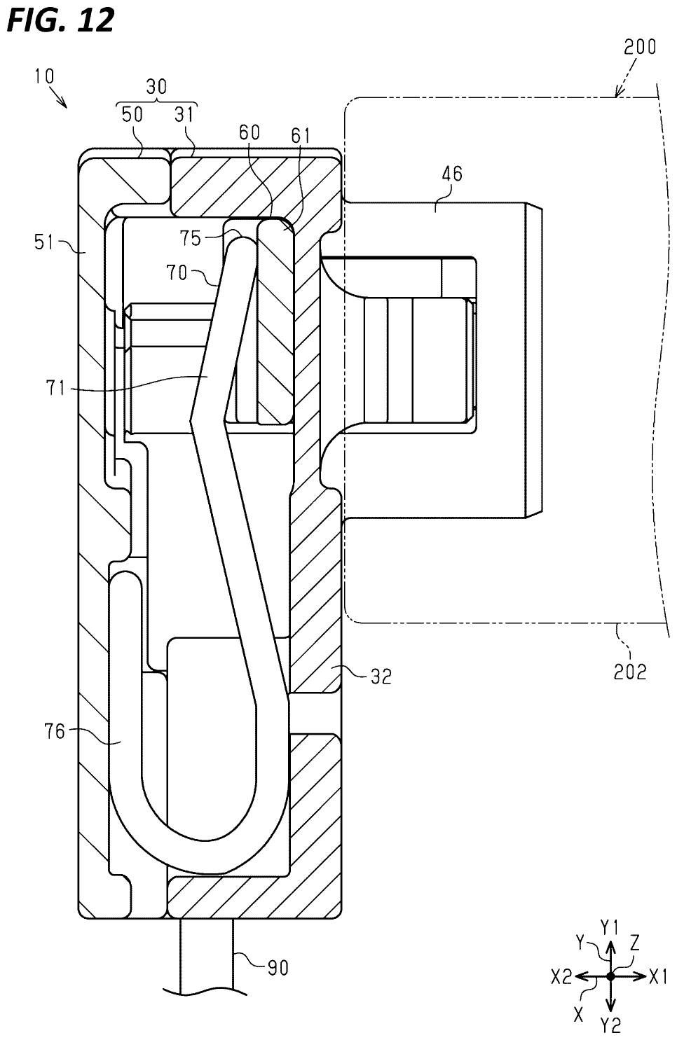

As shown in FIGS. 9 to 12, the slider 60 is accommodated inside the housing 30. The slider 60 is held movably to a first position (see FIGS. 9 and 12) and a second position (see FIGS. 10 and 11) along the first axis X by the housing body 31. As shown in FIGS. 9 and 12, the first position is a position where the body portion 61 is engaged with the base portion 32 of the housing body 31 along the first axis X. As shown in FIGS. 10 and 11, the second position is a position where the slider 60 is pressed in the rearward direction X2 by the mating housing 202. The second position is a position located further in the rearward direction X2 than the first position, specifically a position closer to the cover member 50 than the first position.

When the housing 30 and the mating housing 202 are connected, the slider 60 is pressed in the rearward direction X2 by the mating housing 202. In this way, the slider 60 moves in parallel from the first position to the second position along the first axis X while compressing the spring 70 along the first axis X against a biasing force of the spring 70. As shown in FIG. 11, if the slider 60 is further pressed by the mating housing 202 with the slider 60 arranged at the second position, the connection guaranteeing portion 68 is resiliently deformed to widen an opening and the mating-side connection guaranteeing portion 204 enters the inside of the connection guaranteeing portion 68. In this way, the slider 60 is allowed to move in the forward direction X1. If the connector 10 and the mating connector 200 are properly connected, the slider 60 arranged at the second position is biased toward the first position by the spring 70 and the slider 60 moves in parallel from the second position to the first position along the first axis X as shown in FIG. 12.

As shown in FIG. 2, the body portion 61 of the slider 60 includes a through hole 62 penetrating through the body portion 61 along the first axis X. The terminal accommodating portion 37 of the housing body 31 is inserted into the through hole 62.

The spring accommodating portion 63 is formed to be able to accommodate a part of the spring 70. The spring accommodating portion 63 is formed to have a U shape in a plan view from the forward direction X1.

As shown in FIG. 11, the connection guaranteeing portion 68 includes two resilient pieces 68A. The two resilient pieces 68A are provided to face each other along the third axis Z. Each resilient piece 68A extends in the forward direction X1 from the body portion 61. Each resilient piece 68A is in the form of a cantilever with a base end connected to the body portion 61 as a fixed end and a tip on a side opposite to the base end as a free end. Each resilient piece 68A is configured to be deflectable along the third axis Z by being resiliently deformed. Each resilient piece 68A is pressed in the rearward direction X2 by the mating-side connection guaranteeing portion 204 when the housing 30 and the mating housing 202 are connected. The two resilient pieces 68A are configured to be deflected in directions away from each other by being pressed by the mating-side connection guaranteeing portion 204.

As shown in FIG. 2, the slider 60 includes two guide protrusions 69. The two guide protrusions 69 are provided to face each other along the third axis Z. Each guide protrusion 69 extends along the first axis X. Each guide protrusion 69 is provided on the inner peripheral surface of the through hole 62. As shown in FIG. 4, each guide protrusion 69 is formed to be fittable into the guide groove 41 of the housing 31. Each guide protrusion 69 is formed to be engageable with the guide groove 41 in both the upward direction Y1 and the downward direction Y2 in a state fit in the guide groove 41. The slider 60 is movable between the first position and the second position along the first axis X with the respective guide protrusions 69 fit in the guide grooves 41.

### Configuration of Spring 70

As shown in FIG. 2, the spring 70 is formed of a wire material. The spring 70 is made of metal. The spring 70 includes a pair of the arms 71 and a coupling portion 75 coupling the pair of arms 71. The spring 70 includes a pair of folded portions 76 provided on end parts of the pair of arms 71 and a pair of extending portions 77 provided on the tips of the pair of folded portions 76. The spring 70 is a single member in which the arms 71, the coupling portion 75, the folded portions 76 and the extending portions 77 are continuously and integrally formed. The spring 70 of this embodiment does not have a torsion coil shape.

The pair of arms 71 are provided to face each other along the third axis Z. Each arm 71 extends along the second axis Y as a whole. Each arm 71 is, for example, bent into an inverted V shape in a plan view viewed along the third axis Z.

The coupling portion 75 couples end parts in the upward direction Y1 of the pair of arms 71. The coupling portion 75 extends along the third axis Z. The coupling portion 75 is accommodated in the spring accommodating portion 63 of the slider 60. The coupling portion 75 is in line contact with the bottom surface of the spring accommodating portion 63.

The pair folded portions 76 are provided to face each other along the third axis

Z. Each folded portion 76 is formed to be folded toward the end part in the upward direction Y1 of each arm 71 from an end part in the downward direction Y2 of each arm 71. Each folded portion 76 is formed to be folded in a direction (here, in the rearward direction X2) away from the base portion 32 of the housing body 31. Each folded portion 76 is folded into a U shape from the end part in the downward direction Y2 of each arm 71. Each folded portion 76 is provided to be able to contact the inner surface of the cover member 50.

Each extending portion 77 extends from the tip (here, end part in the upward direction Y1) of each folded portion 76 toward the other arm 71. Each extending portion 77 extends along the third axis Z. The pair of extending portions 77 are provided apart from each other. In other words, a gap is provided between the pair of extending portions 77. Each extending portion 77 is provided to be able to contact the inner surface of the cover member 50.

### Configuration of Ferrite Core 80

The ferrite core 80 is mounted on the outer peripheries of the wires 90. The ferrite core 80 is formed to surround the outer peripheries of the wires 90. The wire 90 is formed to pass through the ferrite core 80 along the second axis Y. The ferrite core 80 is accommodated in the ferrite accommodating portion 38 of the housing body 31.

Next, functions and effects of this embodiment are described.
(1) The connector 10 is provided with the terminals 20, the housing 30 for holding the terminals 20, the slider 60 to be accommodated inside the housing 30 and provided movably to the first position and the second position along the first axis X and the spring 70 for biasing the slider 60. The terminal 20 includes the female terminal portion 22 extending along the first axis X and the wire connecting portion 21 extending along the second axis Y intersecting the first axis X. The female terminal portion 22 includes the groove-like connecting portion 23 connected to the wire connecting portion 21 and the tubular portion 24 extending in a first direction (in this embodiment, the forward direction X1), which is one direction along the first axis X, from the end part of the connecting portion 23. The connecting portion 23 is open in a first opposite direction (in this embodiment, the rearward direction X2), which is the direction opposite to the first direction. The housing 30 includes the housing body 31 having the terminal accommodating portion 37 for accommodating the terminals 20, and the cover member 50 to be attached to the housing body 31. The cover member 50 includes the projections 52 to be inserted into the connecting portions 23 and formed to be engageable with the connecting portions 23 along the second axis Y.

According to this configuration, if the cover member 50 is attached to the housing body 31 accommodating the terminals 20 in the terminal accommodating portion 37, the projections 52 of the cover member 50 are inserted into the groove-like connecting portions 23. At this time, the projections 52 are provided to be engageable with the connecting portions 23 along the second axis Y. By the engagement of these projections 52 and connecting portions 23, the terminals 20 can be suitably suppressed from moving along the second axis Y inside the housing 30. As a result, positional deviations of the terminals 20 inside the housing 30 can be suitably suppressed.
(2) The connecting portion 23 includes the base portion 25 and the first wall portion 26 provided in the end part of the base portion 25 in a second direction (in this embodiment, the upward direction Y1), which is one direction along the second axis Y. The connecting portion 23 includes the second wall portion 27 provided in the end part of the base portion 25 in a second opposite direction (in this embodiment, the downward direction Y2), which is a direction opposite to the second direction. Each of the first and second wall portions 26, 27 projects in a third direction (in this embodiment, the first width direction Z1) intersecting both the forward direction X1 and the upward direction Y1. The projection 52 is formed to be engageable with the first wall portion 26 in the upward direction Y1 and formed to be engageable with the second wall portion 27 in the downward direction Y2.

According to this configuration, the projection 52 is provided to be engageable with the first wall portion 26 of the connecting portion 23 in the upward direction Y1. By the engagement of these projection 52 and first wall portion 26, the terminal 20 can be suitably suppressed from moving in the downward direction Y2 inside the housing 30. Further, the projection 52 is provided to be engageable with the second wall portion 27 of the connecting portion 23 in the downward direction Y2. By the engagement of these projection 52 and second wall portion 27, the terminal 20 can be suitably suppressed from moving in the upward direction Y1 inside the housing 30. As just described, the terminal 20 can be suitably suppressed from moving in the upward direction Y1 and the downward direction Y2 inside the housing 30 by the engagement of the projection 52 with the first and second wall portions 26, 27. As a result, a positional deviation of the terminal 20 inside the housing 30 can be suitably suppressed.
(3) The projection 52 can hold the terminal 20 from the inside of the connecting portion 23 by being engaged with the first and second wall portions 26, 27. In this way, even if the wire 90 connected to the terminal 20 is, for example, pulled in the downward direction Y2, the terminal 20 can be held by the projection 52, wherefore the deformation of the terminal 20 can be suppressed.
(4) The rotation restricting portion 53 of the cover member 50 is formed to be engageable with the second wall portion 27 in the rotation direction of the terminal 20 around the first axis X. By the engagement of the second wall portion 27 with this rotation restricting portion 53, the terminal 20 can be restricted from rotating around the first axis X. In this way, a positional deviation of the terminal 20 associated with the rotation of the terminal 20 can be suitably suppressed.
(5) Further, since the rotation of the terminal 20 can be restricted by the rotation restricting portion 53, the damage and wear of the terminal 20 due to that rotation can be reduced. Furthermore, the sliding and wear of the terminal 20 and the mating terminal 201 can be reduced with the connector 10 and the mating connector 20 properly connected.
(6) The engaging surface 53A of the cover member 50 is formed to be engageable with the end surface in the circumferential direction of the first wall portion 26 in the rotation direction of the terminal 20 around the first axis X. By the engagement of the first wall portion 26 with this engaging surface 53A, the terminal 20 can be restricted from rotating around the first axis X. In this way, a positional deviation of the terminal 20 associated with the rotation of the terminal 20 can be suitably suppressed.
(7) The base end part 52A of the projection 52 is provided to be engageable with the first wall portion 26 of the connecting portion 23 along the first axis X. By the engagement of these base end part 52A and first wall portion 26, the terminal 20 can be suitably suppressed from moving in the rearward direction X2 inside the housing 30. As a result, a positional deviation of the terminal 20 inside the housing 30 can be suitably suppressed.
(8) The position restricting portion 54 is provided to be engageable with the wire connecting portion 21 along the first axis X. By the engagement of these position restricting portion 54 and the wire connecting portion 21, the terminal 20 can be suitably suppressed from moving in the rearward direction X2 inside the housing 30. As a result, a positional deviation of the terminal 20 inside the housing 30 can be suitably suppressed.
(9) By providing the position restricting portion 54, a contact area of the cover member 50 and the terminal 20 can be increased. In this way, the position of the terminal 20 can be restricted by a large surface, and a movement of the terminal 20 inside the housing 30 can be suitably suppressed.

### Modifications

The above embodiment can be modified and carried out as follows. The above embodiment and the following modifications can be carried out in combination without technically contradicting each other.
The structure of the housing 30 in the above embodiment may be changed as appropriate.
The engagement structure of the housing body 31 and the cover member 50 may be changed as appropriate.
Although the housing body 31 and the cover member 50 are constituted by separate components in the housing 30 of the above embodiment, there is no limitation to this. For example, the housing body 31 and the cover member 50 may be integrally formed via a hinge or the like.
Although the housing 30 is composed of two divided bodies, i.e. the housing body 31 and the cover member 50, in the above embodiment, there is no limitation to this. For example, the housing 30 may be composed of three or more divided bodies.
The structure of the cover member 50 may be changed as appropriate. The position restricting portions 54 may be omitted. The rotation restricting portions 53 may be omitted.
The structure of the housing body 31 may be changed as appropriate. The guide grooves 41 may be omitted. The cut portions 43 may be omitted.
The structure of the spring 70 in the above embodiment may be changed as appropriate.
The extending portions 77 of the spring 70 may be omitted.
The structure of each arm 71 may be changed.
The coupling portion 75 of the spring 70 may be omitted.
The structure of the slider 60 in the above embodiment may be changed as appropriate.
The guide protrusions 69 of the slider 60 may be omitted.
The structure of the connection guaranteeing portion 68 may be changed as appropriate.
The ferrite core 80 in the above embodiment may be omitted.
The embodiment disclosed this time should be considered illustrative in all aspects, rather than restrictive. The scope of the present invention is represented not by the above meaning, but by claims and is intended to include all changes in the scope of claims and in the meaning and scope of equivalents.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector, comprising:
a terminal;
a housing for holding the terminal;
a slider to be accommodated inside the housing, the slider being movable to a first position and a second position along a first axis; and
a spring for biasing the slider,
the terminal including a female terminal portion extending along the first axis and a wire connecting portion extending along a second axis intersecting the first axis,
the female terminal portion including a groove-like connecting portion to be connected to the wire connecting portion and a tubular portion extending in a first direction from an end part of the connecting portion, the first direction being one direction along the first axis,
the connecting portion being open in a first opposite direction opposite to the first direction,
the housing including a housing body having a terminal accommodating portion for accommodating the terminal and a cover member to be attached to the housing body, and
the cover member including a projection to be inserted inside the connecting portion, the projection being formed to be engageable with the connecting portion along the second axis.

2. The connector of claim 1, wherein:
the housing body is formed into a box open in the first opposite direction, and
the cover member includes a body portion for closing an opening in the first opposite direction of the housing body and the projection projecting in the first direction from the body portion.

3. The connector of claim 2, wherein:
the connecting portion includes a base portion, a first wall portion provided in an end part in a second direction of the base portion, the second direction being one direction along the second axis, and a second wall portion provided in an end part in a second opposite direction of the base portion, the second opposite direction being opposite to the second direction,
each of the first wall portion and the second wall portion projects in a third direction intersecting both the first direction and the second direction, and
the projection is formed to be engageable with the first wall portion in the second direction and formed to be engageable with the second wall portion in the second opposite direction.

4. The connector of claim 3, wherein:
the cover member includes a rotation restricting portion extending in the second opposite direction from the projection, and
the rotation restricting portion is formed to be engageable with the second wall portion in a rotation direction of the terminal around the first axis.

5. The connector of claim 4, wherein:
the connecting portion includes a cut portion provided in an end part in the first opposite direction of the first wall portion,
the projection includes a cylindrical base end part connected to the body portion and a cylindrical tip part projecting in the first direction from the base end part,
an outer diameter of the tip part is smaller than an outer diameter of the base end part, and
an end surface in the first direction of the base end part is formed to be engageable with an end surface in the first opposite direction of the first wall portion exposed by the cut portion along the first axis.

6. The connector of claim 5, wherein:
the second wall portion is facing the rotation restricting portion in the third direction,
the projection has an engaging surface extending in the third direction from the tip part,
the first wall portion is formed into a curved shape along an outer peripheral surface of the tip part, and
the engaging surface is formed to be engageable with an end surface in a circumferential direction of the first wall portion in the rotation direction.

7. The connector of claim 2, wherein:
the cover member includes a position restricting portion projecting in the first direction from the body portion, and
the position restricting portion is formed to be engageable with the wire connecting portion along the first axis.
